(19) United States
(12) Patent Application Publication
(10) Pub. No.: US 2015/0040763 A1
(43) Pub. Date: Feb. 12, 2015

(54) AXIALLY SECTIONED CERAMIC HONEYCOMB ASSEMBLIES

(71) Applicant: Dow Global Technologies LLC, Midland, MI (US)

(72) Inventors: James J. O'Brien, Midland, MI (US); Jun Cai, Midland, MI (US); Ashish Kotnis, Troy, MI (US); Paul C. Vosejpka, Midland, MI (US)

(21) Appl. No.: 14/381,354

(22) PCT Filed: Mar. 27, 2013
(86) PCT No.: PCT/US13/34114

§ 371 Date: Aug. 27, 2014

Related U.S. Application Data
(60) Provisional application No. 61/636,812, filed on Apr. 23, 2012.

(51) Int. Cl. B01D 46/24; B01D 46/00; F01N 3/022

(52) U.S. Cl. CPC B01D 46/247; F01N 3/0222; B01D 46/0001
USPC 95/273; 55/523; 29/428

(57) ABSTRACT

Ceramic honeycomb assemblies are made from ceramic honeycomb sections arranged sequentially in an axial direction. The plugging patterns of the cells in the various sections are varied so that a portion of a fluid entering the assemblies can pass through upstream section(s) of the assembly without being filtered. One or more downstream sections capture particulate matter that has passed through the upstream sections without being filtered. This design reduces “ring-off” cracking, and high filtration capacity, with little increase in pressure drop during operation.

This invention relates to axially sectioned ceramic honeycomb assemblies.

Ceramic honeycombs are widely used as filters and as catalyst supports in a variety of applications. They are frequently used to treat fluids such as combustion gases, by filtering out particulates (such as soot particles) and/or aerosol droplets, or as carriers for catalytic materials that catalyze the conversion of certain components of the exhaust (such as NOₓ compounds) to benign compounds (such as N₂ and H₂O). Such honeycombs are also useful to filter or catalyze liquids such as water and organic solvents and solutions.

The ceramic honeycombs have multiple channels (or “cells”) that extend axially along the length of the honeycomb. The cells are defined by intersecting walls that extend axially along the length of the honeycomb. The cells formed by these intersecting walls provide a flow path from an upstream inlet end of the honeycomb to a downstream outlet end. A portion of the cells typically is plugged at the outlet end, and another portion of the cells is plugged at the inlet end. Cells that are plugged at the outlet end are open at the inlet end, forming inlet cells through which the gas enters the honeycomb. Cells that are plugged at the inlet end are open at the outlet end, forming outlet cells through which the fluid exits the honeycomb. A “checkerboard” plugging pattern, which creates alternating inlet and outlet cells, is typical.

The intersecting cell walls are porous and thus permeable to fluids. As fluids enter the inlet cells, they pass through the walls into adjacent outlet cells from which the fluids exit the honeycomb. Entrained materials that cannot permeate the walls (such as solid particles) are captured and are thus removed from the fluid. Honeycomb structures are often referred to as “wall flow” devices, because the fluids pass through cell walls in this manner. The fluids are filtered and/or contact the active catalyst material as they pass through the porous wall(s).

A cracking problem is often seen when ceramic honeycombs are used to treat hot fluids, such as exhaust gases from stationary power plants or mobile power plants (such as internal combustion engines). Temperature gradients often form within the honeycomb during operation, especially during transitional periods such as start-up and during “burn-out” cycling, during which operating temperatures are temporarily increased to ignite and burn out soot that has become trapped in the filter, and then returned to normal operating temperatures. The temperature gradients often cause mechanical stresses to develop within the honeycomb as different portions of the honeycomb thermally expand or contract at different rates. Cracks develop as a result of these mechanical stresses. The ability of a ceramic honeycomb to withstand this thermally-induced cracking can be expressed as its “thermal shock resistance”.

One of the ways of improving thermal shock resistance in a ceramic honeycomb is to segment it. Instead of forming the entire honeycomb structure from a single, monolithic body, a number of smaller honeycombs are made separately, and then assembled into a larger structure. The segments are joined lengthwise, along planes that run in the axial direction of the filter. An inorganic cement is used to bond the smaller honeycombs together. The inorganic cement is in general more elastic than are the honeycomb structures. It is this greater elasticity that allows thermally-induced stresses to dissipate through the structure, reducing high localized stresses that might otherwise cause cracks to form. The segments used are also smaller in size and less prone to experience large thermal gradients and associated thermal stresses during use. Examples of the segmenting approach are seen in U.S. Pat. No. 7,112,233, U.S. Pat. No. 7,384,441, U.S. Pat. No. 7,488,412, and U.S. Pat. No. 7,666,240.

The segmenting approach has proven to be effective mainly in reducing axial cracking (cracks that form generally along a line or plane parallel to the fluid flow and channel axis). The segmenting approach can help reduce radial cracking (cracks that form generally along a line or plane perpendicular to the fluid flow and channel axis; often referred to as “ring-off” cracks). But segmenting approaches have not been found to be effective enough in reducing ring-off cracking. Therefore, another or an additional approach is needed to deal with the problem of the ring-off cracking.

In many cases, the honeycomb supports one or more catalytic materials. The catalytic material typically is deposited onto the honeycomb walls through a coating process in which the filter is impregnated with a solution or suspension of the catalytic material (or precursor thereto), to coat the honeycomb walls with the catalyst material or precursor. Subsequent drying and/or firing produces a coating of catalytic material. Sometimes, it is only necessary to coat a portion of the honeycomb in order to provide enough of the catalyst for the end application. In other situations, it may be desirable to coat different portions of the honeycomb with different catalytic materials. So-called “zone coating” methods attempt to address this need. In zone-coating methods, only a portion of the honeycomb is contacted with the coating fluid. However, the coating fluid “wicks” into the porous honeycomb structure and therefore spreads beyond the initially wetted area of the honeycomb. This makes it difficult to produce partially coated honeycombs, or honeycombs having two or more catalytic materials in distinct regions. Therefore, it is desirable to provide a method whereby one may conveniently produce a ceramic honeycomb that is only partially coated with a catalytic material, or in which different portions of the honeycomb are coated with different catalytic materials.

U.S. Pat. No. 8,007,731 describes a “layered” ceramic honeycomb structure in which multiple ceramic honeycomb “layers” are arranged axially with gaps between the successive honeycomb layers. This device is intended mainly as a catalyst support. The cells of the honeycomb are for the most part open at each end, so a fluid passing through the cells can pass through each of the layers without passing through a cell wall. The fluid makes contact with catalytic material deposited on the cell walls as it passes through the cells. Particulate material is not removed because the fluid does not pass through the cell walls. Individual honeycomb layers can be plugged in a “checkerboard” pattern to force the fluid to pass through the cell walls and filter particulate matter therefrom. Such a layered structure has very little capacity for capturing particulate matter due to the absence or near-absence of plugged layers that can act as filters, resulting in an inefficient use of available filter wall area to accumulate soot.

This invention is in one aspect a ceramic honeycomb assembly comprising one or more pass-through ceramic honeycomb sections, and one or more downstream ceramic honeycomb sections, the ceramic honeycomb sections being arranged sequentially in an axial direction with a gap between each sequential pair of honeycomb sections, structural means for holding said honeycomb segments in fixed spatial relation to each other and enclosure means for enclosing the periphery of the gap or gaps between each sequential pair of honeycomb sections, wherein:

(a) at least one downstream ceramic honeycomb section is positioned downstream of at least one pass-through ceramic honeycomb section;

(b) the pass-through and downstream ceramic honeycomb sections each have multiple axially-extending cells that are defined by intersecting porous walls;

(c) the axially-extending cells of the pass-through ceramic honeycomb section or sections and the axially-extending cells of the downstream honeycomb section or sections together define multiple fluid flow paths through the ceramic honeycomb assembly from an upstream end to a downstream end;

(d) each pass-through ceramic honeycomb section includes (i) at least 15% by number of pass-through cells that are open at each end to form pathways for a fluid to flow through the pass-through ceramic honeycomb without passing through a cell wall and (ii) inlet cells that are closed at an outlet end of said pass-through ceramic honeycomb section but not an inlet end thereof, such that a fluid entering such inlet cells must pass through at least one cell wall as it passes through said pass-through ceramic honeycomb; and

(e) each downstream ceramic honeycomb section includes (i) outlet cells that are closed at an inlet end but not at an outlet end of said downstream ceramic honeycomb section, and (ii) inlet cells that are closed at an outlet end but not an inlet end of said downstream ceramic honeycomb section, such that a fluid entering an inlet end of said inlet cells must pass through a cell wall to be removed from the outlet end of said downstream ceramic honeycomb, and (iii) 0 to 10% by number of pass-through cells that are open at each end to form pathways for a fluid to flow through the downstream ceramic honeycomb without passing through a cell wall.

Applicants have discovered that the problem of ring-off cracking in ceramic honeycombs can be ameliorated by dividing the honeycomb axially, i.e., along planes that run perpendicular to the axial extension of the honeycomb. Thus, a feature of the honeycomb assembly of the invention is that the assembly includes two or more honeycomb sections that are arranged sequentially from an upstream to a downstream direction. Ring-off cracking is reduced, compared to an otherwise like (including physical dimensions) honeycomb that is not so divided.

Because the honeycomb sections can be produced separately and then assembled together, it is convenient to apply a catalytic material to some portion of the sections and produce an assembly in which the catalytic material is present only in defined locations. Similarly, different catalytic materials can be applied to different honeycomb sections, which are then assembled to produce an assembly having two or more different catalytic materials in discrete locations.

Applicants have further found that modifications of conventional plugging patterns become necessary when a honeycomb is axially divided. If the cells on both the inlet and outlet ends of the individual sections are plugged in a standard checkerboard section (such as is described with respect to some honeycomb “layers” in U.S. Pat. No. 8,007,731), a substantial loss of filtering capacity (i.e., the amount of particulate matter (including ash formed during burn-out cycling) that the filter can capture before the filter must be replaced or regenerated) is seen. This problem is overcome with this invention via the use of different plugging patterns in the various sections, and in particular the presence of at least one section (a “pass-through” section) that has pass-through cells, upstream of another section (a “downstream” section) that has few and preferably no such pass-through cells.

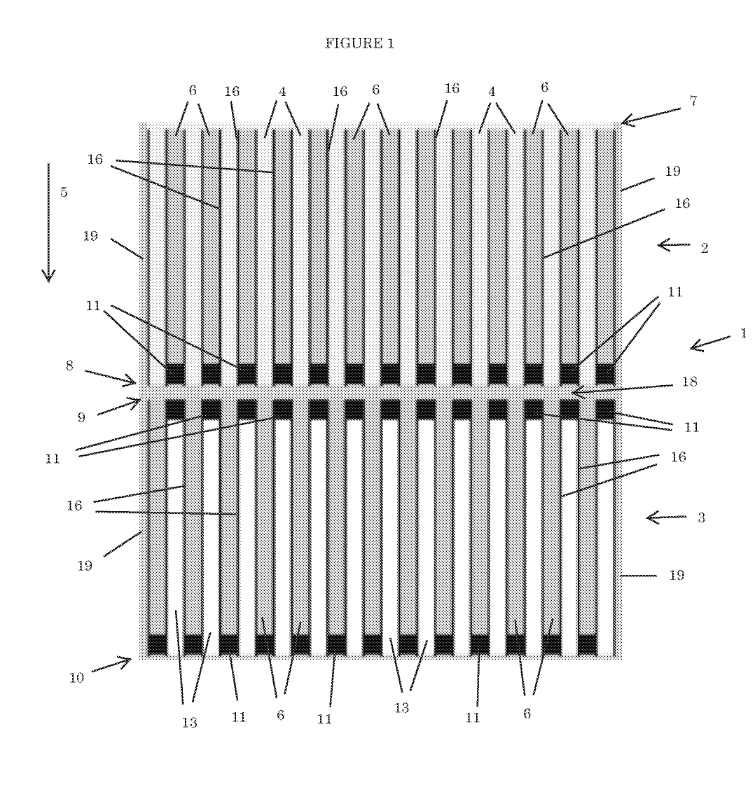

FIG. 1 is a cross-sectional view of an embodiment of the invention, in which a single pass-through section is followed by a downstream section.

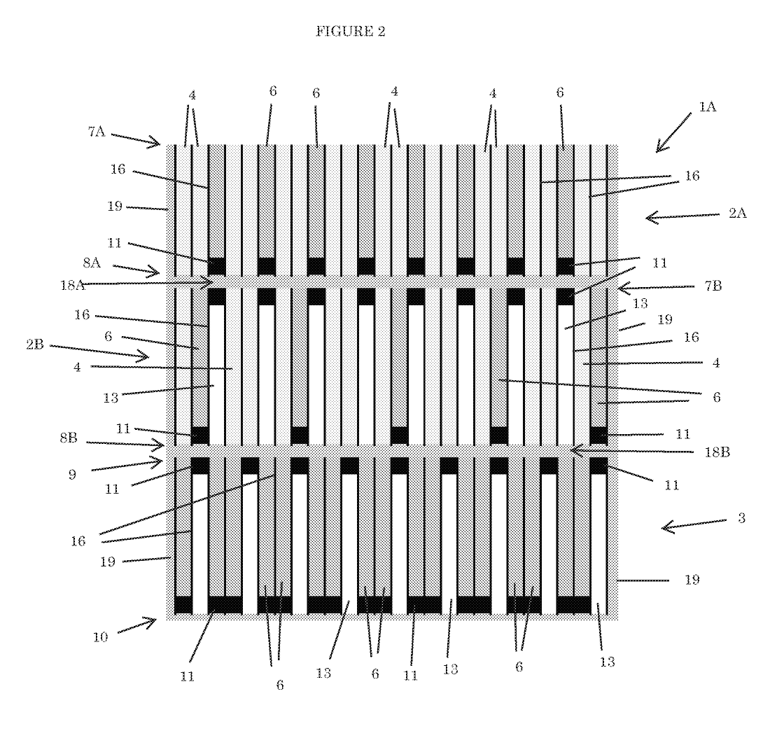

FIG. 2 is a cross-sectional view of an embodiment of the invention, in which two pass-through sections are followed by a downstream section.

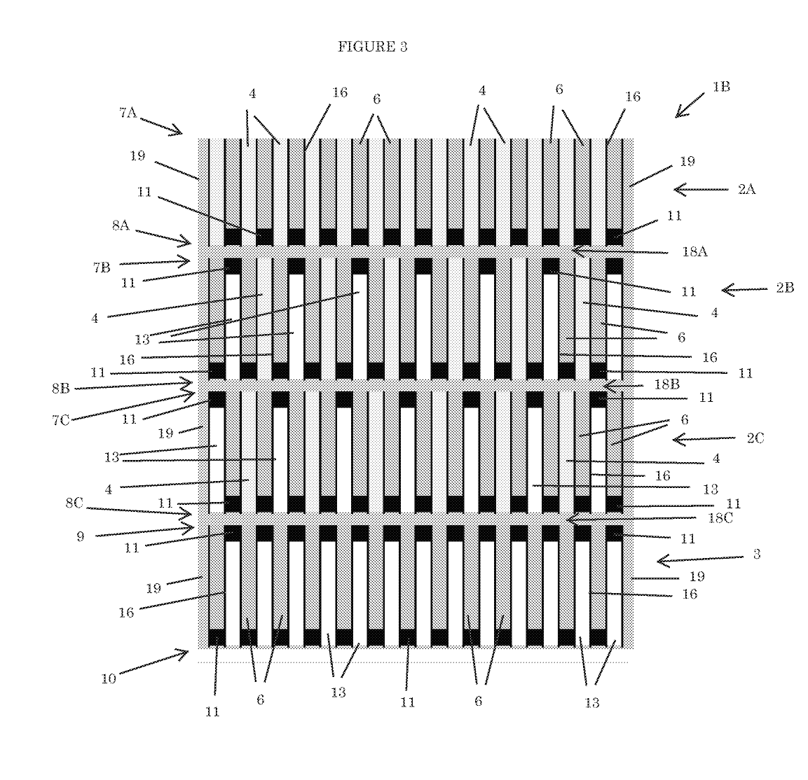

FIG. 3 is a cross-section view of an embodiment of the invention, in which three pass-through sections are followed by a downstream section.

FIG. 4 is a cross-section view of an embodiment of the invention, which is axially sectioned and radially segmented.

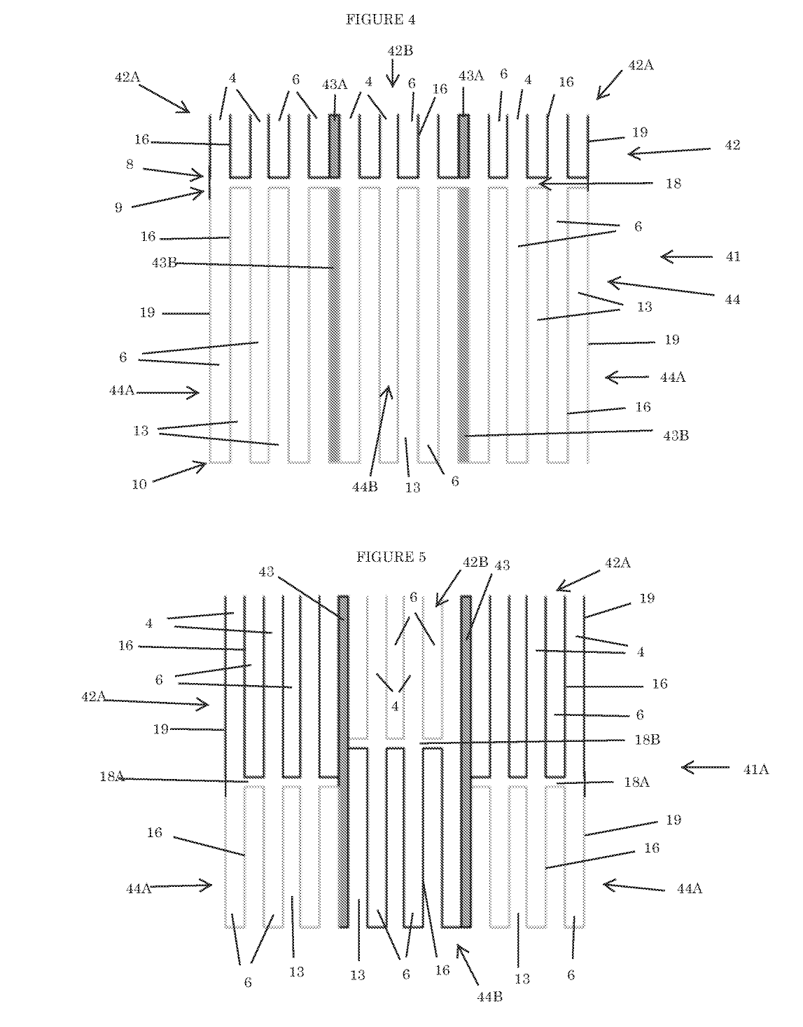

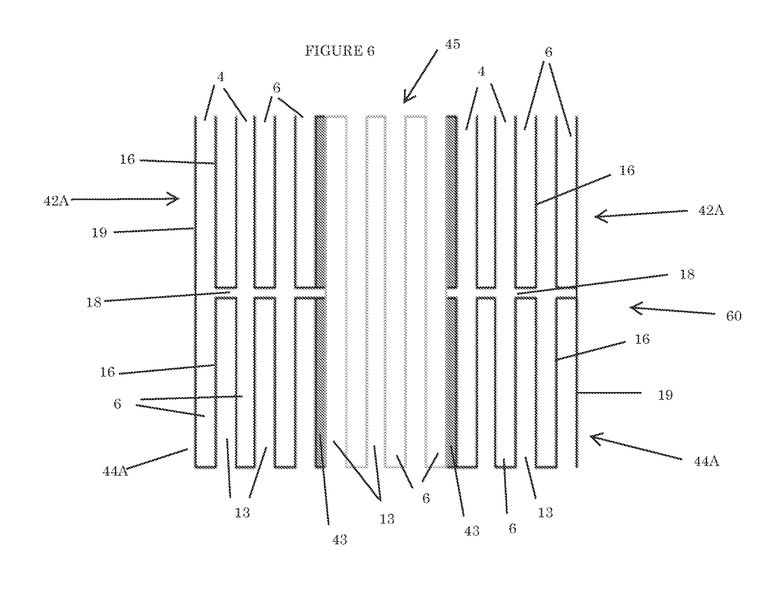

FIG. 5 is a cross-section view of another embodiment of the invention, which is axially sectioned and radially segmented.

FIG. 6 is a cross-section view of yet another embodiment of the invention, which is axially sectioned and radially segmented.

The axially-extending cells of the ceramic honeycomb sections are characterized as being of three distinct types. “Pass-through” cells are open at each end. Pass-through cells therefore form pathways for a fluid to flow through a ceramic honeycomb section without passing through a cell wall.

“Inlet” cells are open at the inlet end of a honeycomb section and closed at an outlet end. For purposes of this invention, the “inlet” end of a honeycomb section, or of the honeycomb assembly as a whole, is the axial end of the section or assembly at which a fluid enters during operation. Conversely, the “outlet” end of a honeycomb section or assembly is the axial end of the section or assembly at which the fluid exits during operation. Because inlet cells are open at the inlet end, fluid can enter the inlet end of such cells during operation. However, because the cells are closed at the outlet end, the fluid cannot pass out of the outlet end of the inlet cells, and must instead pass through a cell wall to be removed from the honeycomb.

“Outlet cells” are closed at the inlet end, so fluid cannot enter the inlet end of such cells, but instead must enter such cells from another cell by passing through at least one cell wall. The outlet cells are open at the outlet end, so fluid can be removed from the outlet end of such cells.

Pass-through honeycomb sections and downstream honeycomb sections differ in the types of cells that they contain. Pass-through honeycomb sections contain at least 15% by number of pass-through cells, and also contain inlet cells. Pass-through honeycomb sections may also contain outlet cells, but this is not required. A pass-through honeycomb section may contain as much as 85% by number of pass-through cells. A pass-through section may contain from 20 to 75%, 25 to 70%, or 33 to 67%, by number of pass-through cells, in specific embodiments. Pass-through honeycomb segments preferably contain at least 15% by number of inlet cells, and more preferably contain at least 25% by number of inlet cells. Pass-through sections may contain as much as 85% by number of inlet cells. A pass-through section may contain 25 to 80%, 30 to 75%, or 33 to 67%, by number of inlet cells, in specific embodiments.

If outlet cells are present in a pass-through section, they may constitute at least 2% or at least 5% of the cells by number, up to 70%, preferably up to 50%, more preferably up to 33% of the cells by number.

Downstream honeycomb sections contain both inlet cells and outlet cells, but no more than 10% by number of pass-through cells. Downstream honeycomb sections preferably contain no more than 5% by number of pass-through cells, more preferably no more than 2% thereof and most preferably contain no pass-through cells. A preferred downstream honeycomb section contains 25 to 75% by number of inlet cells and 25 to 75% by number outlet cells, the inlet and outlet cells together constituting at least 95%, more preferably at least 98%, still more preferably 100% of the cells of the downstream honeycomb section.

The honeycomb assembly of the invention contains at least one downstream section positioned downstream from at least one pass-through section. The honeycomb assembly may contain any greater number of pass-through sections. Thus, the honeycomb assembly may contain 1, 2, 3, 4, 5 or any greater number of pass-through sections. The honeycomb assembly may contain more than one downstream section, but there is generally little advantage in providing more than one downstream section. The last (i.e., most downstream) axial honeycomb section in the honeycomb assembly preferably is a downstream section. In a preferred arrangement, the honeycomb assembly includes one or more pass-through sections in sequence, followed by one or more, preferably one, downstream section, the downstream section(s) being the last of the honeycomb sections in the assembly. Most preferably, the assembly contains at least one downstream honeycomb section that contains no pass-through cells, which is the last (most downstream) of the honeycomb sections in the assembly.

An embodiment of a two-section honeycomb assembly of the invention is illustrated in FIG. 1. In FIG. 1, ceramic honeycomb assembly 1 includes pass-through honeycomb section 2 and downstream honeycomb section 3. Arrow 5 indicates the axial direction of ceramic honeycomb assembly 1 as well as the general direction of fluid flow through ceramic honeycomb assembly 1 from an inlet end generally indicated by arrow 7 towards and an outlet end generally indicated by arrow 10. In this embodiment, arrow 7 also indicates the inlet end of pass-through honeycomb section 2 and arrow 10 also indicates the outlet end of downstream honeycomb section 3.

Pass-through honeycomb section 2 contains axially-extending cells 4 and 6 which are defined by porous cell walls 16. Pass-through cells 4 are open at each end (i.e. at inlet end 7 and pass-through honeycomb outlet end 8), and form a pathway through which a fluid entering pass-through honeycomb section 2 at inlet end 7 can pass through the pass-through honeycomb section 2 and exit at outlet end 8, without passing through any cell wall 16. Inlet cells 6 are open at inlet end 7 and blocked at outlet end 8 with plugs 11. Fluid entering inlet cells 6 must pass through one or more cell walls 16 to a pass-through cell 4 as it passes through pass-through honeycomb section 2 toward outlet end 8.

Downstream honeycomb section 3 contains inlet cells 6 and outlet cells 13 that are defined by porous walls 16. Inlet cells 6 are closed with plugs 11 at outlet end 10, and are open at inlet end 9. Outlet cells 13 are closed with plugs 11 at inlet end 9 and are open at outlet end 10. A fluid entering downstream honeycomb section 3 at inlet end 9 must enter through inlet cells 6 and must pass through one or more cell walls 16 to an outlet cell 13 as it passes through downstream ceramic honeycomb section 3 toward outlet end 10.

Pass-through honeycomb section 2 and downstream honeycomb section 3 are separated by gap 18. Gap 18 defines a space through which a fluid exiting pass-through honeycomb section 2 passes before entering downstream honeycomb section 3.

During operation, a portion of a fluid entering pass-through honeycomb section 2 enters into pass-through cells 4, and another portion enters into inlet cells 6. The pressure is higher at inlet end 7 than at outlet end 10, so the general direction of fluid flow through honeycomb assembly 1 is in the direction indicated by arrow 5. The portion of the fluid that enters into pass-through cells 4 at inlet end 7 can pass through pass-through honeycomb section 2 without passing through any cell wall 16. It is possible that some fluid entering pass-through cells 4 may pass through a cell wall 16 to an adjacent cell, as a result of localized turbulent flow, or if the pressure drop across honeycomb assembly 1 is small. However, in most cases, it is believed essentially all fluid entering inlet end 7 of pass-through cells 4 will pass through honeycomb segment 2 without passing through any cell wall 16.

That portion of the fluid entering inlet cells 6 must pass through a cell wall 16 as it passes through pass-through honeycomb section 2 to gap 18.

Any fluid that does not pass through a cell wall 16 as it passes through pass-through honeycomb section 2 will be minimally filtered, if filtered at all, in that honeycomb section 2. Although some entrained particles or droplets may deposit along walls 16 as the fluid passes through a pass-through cell 4, most of those particles or droplets will not make contact with a wall 16 and become deposited thereon, but instead will be carried through pass-through honeycomb section 2, into gap 18 and then into downstream ceramic honeycomb 3.

Conversely, any fluid that enters into inlet cells 6 in pass-through section 2 will become filtered as the fluid passes through a cell wall 16 on its path through pass-through honeycomb section 2.

As a result of the presence of both types of cells (pass-through cells 4 and inlet cells 6), a portion of the particles or droplets contained in the fluid are deposited onto at least some of porous walls 16 of honeycomb section 2, and another portion of the particles or droplets is carried through into downstream honeycomb section 3. This is an important feature and advantage of the invention, because it allows the honeycomb assembly to be formed in axial sections without a severe reduction in filtering capacity or filtering efficiency. If pass-through cells 4 were not present, most or all of the particles (and ash that forms from the captured particles during burn-out cycling) or droplets would be captured in pass-through honeycomb section 2. Few if any of such particles (and resulting ash) or droplets would pass into downstream ceramic honeycomb section 3. In effect, the filtering capacity of the filter would be substantially limited to that of pass-through honeycomb section 2 by itself. The presence of pass-through cells 4 allows particles or droplets to be carried into downstream ceramic honeycomb 3 and become deposited there. Because particles (and resulting ash) and droplets can be captured in both pass-through honeycomb section 2 and downstream section 3, the capacity of honeycomb assembly 1 is much larger than that of pass-through honeycomb section 2 alone.

Fluid exiting through outlet end 8 of pass-through honeycomb section 2 passes through gap 18 and from there enters downstream ceramic honeycomb section 3. Because outlet cells 13 are closed with plugs 11 at inlet end 9 of downstream ceramic honeycomb section 3, the fluid cannot enter outlet cells 13 at that end, and instead enters downstream ceramic honeycomb section 3 through inlet cells 6. Because inlet cells 6 are closed with plugs 11 at outlet end 10, fluid entering inlet cells 6 must pass through at least one cell wall 16 into an outlet cell 13 to be removed from outlet end 10. Because all of the cells of downstream honeycomb section 3 are either inlet cells 6 or outlet cells 13 (in the embodiment shown), all of the fluid passing through downstream ceramic honeycomb section 2 is filtered in that section. In particular, fluid that passed through pass-through cells 4 of pass-through honeycomb section 2 without being filtered will become filtered as that fluid passes through downstream honeycomb section 3.

The concept can be extended to any larger of sequentially arranged honeycomb sections, provided that at least one pass-through honeycomb section as described is present, and at least one downstream section as described is also present, the downstream section being located downstream (i.e., axially in the direction of fluid flow through the assembly) of at least one pass-through section. Typically, a downstream section as described will be the last section in the sequence. Although is possible to include one or more additional sections after a downstream section as described, such sections are generally unnecessary as few if any particles or droplets will pass through a downstream section. It is possible, however, to include two or more downstream sections in the assembly. As before, it is preferred that the last section in the assembly is a downstream section, and more preferred that such last downstream section contains no pass-through cells.

FIG. 2 illustrates an embodiment in which two pass-through sections precede a downstream section. In FIG. 2, honeycomb assembly 1A includes, in sequence, pass-through honeycomb sections 2A and 2B, followed by downstream section 3. Pass-through honeycomb section 2A includes pass-through cells 4 and inlet cells 6, as described with respect to FIG. 1. Porous walls 16 are located between adjacent cells. Plugs 11 close the outlet end of inlet cells 6. Reference number 7A indicates the inlet end of pass-through section 2A, at which a fluid to be treated will be introduced into pass-through honeycomb 2A and honeycomb assembly 1A as a whole. 8A indicates the outlet end of pass-through honeycomb section 2A.

Pass-through honeycomb section 2B is downstream of pass-through honeycomb section 2A and separated therefrom by gap 18A. Pass-through honeycomb section 2B includes pass-through cells 4, and inlet cells 6 which are closed at outlet end 8B with plugs 11 and open at inlet end 7B. Pass-through cells 4 and inlet cells 6 of pass-through honeycomb section 2B perform the same functions as described with regard to the corresponding features in FIG. 1. In addition, pass-through honeycomb section 2B includes optional outlet cells 13, which are blocked at inlet end 7B with plugs 11 and open at outlet end 8B. As before, adjacent cells in pass-through honeycomb section 2B are separated by porous walls 16. Reference number 7B indicates the inlet end of pass-through section 2B, at which a fluid to be treated will be introduced into pass-through honeycomb 2B after exiting outlet end 8A of pass-through honeycomb section 2A and passing through gap 18A. 8B indicates the outlet end of pass-through honeycomb section 2B.

Still referring to FIG. 2, downstream honeycomb section 3 is downstream of pass-through honeycomb 2B and separated therefrom by gap 18B. Downstream honeycomb section 3 contains inlet cells 6 that are closed at outlet end 10 by plugs 11 and open at inlet end 9, and outlet cells 13 that are closed at inlet end 9 by plugs 11 and open at outlet end 10. As before, cells 6 and 13 are separated by porous walls 16. A fluid to be treated is introduced into inlet end 9 of downstream honeycomb 3 after exiting outlet end 8B of pass-through honeycomb section 2B and passing through gap 18B. The fluid passes into inlet cells 6 of downstream honeycomb section 3, passes through at least one wall 16 into outlet cells 13 and then out of outlet end 10 of downstream honeycomb section 3.

FIG. 3 illustrates an embodiment (1B) that includes, in sequence, three pass-through sections, 2A, 2B and 2C, followed by a single downstream section 3. Gap 18A separates pass-through section 2A and 2B, gap 18B separates pass-through sections 2B and 2C, and gap 18C separates pass-through section 2C and downstream section 3. Each of pass-through honeycomb sections 2A-2C includes pass-through cells 4 and inlet cells 6 which are closed with plugs 11 at outlet ends 8A, 8B and 8C of the respective honeycomb sections. In addition, pass-through honeycomb sections 2B and 2C each contain outlet cells 13 which are closed with plugs 11 at inlet ends 7B and 7C of the respective sections. Downstream honeycomb section 3 contains inlet cells 6, which are closed at outlet end 10 with plugs 11 and open at inlet end 9, and outlet cells 13, which are closed at inlet end 9 by plugs 11 and open at outlet end 10. As before, porous walls 16 separate adjacent cells.

Honeycomb assemblies of the invention that contain 3 or more sections operate analogously to the two-section honeycomb assembly shown in FIG. 1. Thus, referring for example to FIG. 2, a fluid entering into inlet end 7A of honeycomb assembly 1A will flow sequentially through pass-through honeycomb section 2A, gap 18A, pass-through honeycomb section 2B, gap 18B and downstream honeycomb section 3 to outlet end 10, where it exits honeycomb assembly 1. Fluid entering an inlet cell 6 of any of honeycomb sections 2A, 2B and 3 must pass through a porous wall 16 to pass through such section, and in doing so becomes filtered in that section. Fluid entering a pass-through cell 4 of a pass-through section 2A or 2B can pass through that section without passing through a cell wall 16 and so will be at most minimally filtered in that section. The presence of pass-through cells 4 in pass-through sections 2A and 2B therefore permits particulates and droplets to be carried downstream to subsequent sections, and in that manner the capacity of honeycomb assembly is not restricted to essentially that of pass-through honeycomb section 2A. Because there are no pass-through cells in downstream honeycomb section 3, essentially no particles or droplets pass entirely through honeycomb assembly 1A.

The four-section honeycomb assembly of FIG. 3 functions in an analogous manner, the pass-through cells of each of pass-through sections 2A, 2B and 2C permitting a portion of a fluid to pass downstream into subsequent sections, including downstream honeycomb section 3, without being filtered, thereby allowing particles and droplets to become captured along the entire length of the honeycomb assembly.

The various honeycomb sections 2, 2A, 2B, 2C and 3 in each of FIGS. 1-3 include peripheral walls 19. In the embodiments shown in FIG. 1-3, peripheral walls 19 serve as both the structural means for holding said honeycomb segments in fixed spatial relation to each other and as the enclosure means for enclosing the periphery of the gap or gaps between each sequential pair of honeycomb sections. Thus, walls 19 hold the various honeycomb sections 2, 2A, 2B, 2C and 3 in the desired spatial relation to each other, i.e., in the requisite order and with the requisite gaps between successive sections. In the embodiments shown in FIGS. 1-3, peripheral walls 19 also enclose the periphery of gaps 18, 18A, 18B and 18C. Peripheral walls 19 preferably are non-porous or have low porosity, so that fluid does not escape out of the respective honeycomb sections or from gaps 18, 18A, 18B and 18C through peripheral wall 19.

Peripheral walls 19 may include or be constituted by an external skin of the honeycomb assembly. Such an external skin can be integral to the honeycomb sections and/or be an applied layer or wrapping. In some cases, peripheral walls 19 may be wholly or partially constituted by a container in which the honeycomb assembly resides. For example, the honeycomb assembly may be contained in a metal or other container, which fits snugly around the periphery of the honeycomb assembly, forming a barrier that prevents a fluid from escaping from the periphery of the honeycomb assembly. Such a container may form all or part of peripheral walls 19. A compressible or expandable mat or foam material can also serve as a peripheral wall between the honeycomb assembly and the container.

As can be seen from FIGS. 1-3, the pass-through cells and inlet cells of any pass-through honeycomb section can be arranged in various patterns, or even randomly. In addition, the relative numbers of the pass-through cells and inlet cells in any pass-through honeycomb section can vary significantly. Thus, in pass-through honeycomb sections 2 of FIG. 1 and 2A of FIG. 3, pass-through cells 4 and outlet cells 6 are arranged in a checkerboard pattern, whereas in pass-through honeycomb section 2A of FIG. 2 those cells are arranged in an A-A-B-A-A-B pattern, where each A represents a pass-through cell and each B represents an inlet cell.

Similarly, when outlet cells are present in a pass-through honeycomb section, various arrangements of the pass-through cells, inlet cells and outlet cells may be used. Thus, in pass-through honeycomb sections 2B and 2C of FIG. 3, these cells are present in a repeating A-B-C-B pattern, where each A represents a pass-through cell, each B represents an inlet cell, and each C represents an outlet cell. If outlet cells are present in a pass-through honeycomb section, each outlet cell preferably is adjacent to (i.e., shares a porous wall with) at least one inlet cell.

If multiple pass-through sections are present, the proportions of pass-through, inlet and outlet cells in the various pass-through sections may be the same in each of the sections, or vary from section to section. Moreover, the arrangement of pass-through, inlet and outlet cells in the various pass-through sections can be the same in all of the sections, or different arrangements can be used in the various sections. If two or more pass-through sections are present in a honeycomb section, the first pass-through section in some embodiments contains no outlet cells, and at least one subsequent pass-through section preferably contains outlet cells in addition to pass-through cells and inlet cells.

The arrangements of the cells shown in FIGS. 1-3 are only illustrative; many other arrangements are also useful. It is noted that although FIGS. 1-3 show the arrangement of cells in only one dimension, the cell patterns in each case would be extended to two orthogonal dimensions. The arrangement of cells in one dimension does not necessarily have to be the same in the other orthogonal dimension.

The arrangement of inlet and outlet cells in a downstream honeycomb section (as well as any pass-through cells as may be present) also can be arranged in various patterns or even randomly. Thus, in FIGS. 1 and 3, cells 6 and 13 of downstream honeycomb section 3 are arranged in an alternating pattern, whereas in FIG. 2 cells 6 and 13 of downstream honeycomb section 3 are arranged in a B-B-C pattern, where, as before, each B represents an inlet cell and each C represents an outlet cell. It is preferred that each outlet cell in a downstream honeycomb section is adjacent to (i.e., shares a porous wall with) at least one inlet cell.

For ease of illustration, the cells of the successive honeycomb sections are shown as being in alignment with each other. However, this is not necessary or even desirable, and the cells may in successive honeycomb sections may be aligned or unaligned. The presence of gaps such as gaps 18, 18A, 18B and 18C in FIG. 1-3 allow a fluid exiting any honeycomb section to distribute itself into the inlet cells (and pass-through cells, if any) of the next successive honeycomb section.

The size of the various pass-through, inlet and outlet cells is not considered as critical to the invention, and may vary widely as needed or desired for a particular end use. A typical honeycomb for many filtration or catalysis applications will contain from 25 to 1000 cells/square inch (about 4 to 150 cells/square centimeter) of cross-sectional area (i.e., transverse to the longitudinal extension of the cells). A preferred cell density for combustion exhaust filtration applications is 100 to 400 cells/square inch (about 16 to 64 cells/square centimeter). It is not necessary that all of the cells in a given section be of the same size, although they may be. It is not necessary that the pass-through cells in a given section be the same size as inlet or outlet cells in such section, although they may be. It is not necessary that cells in different sections be of the same size, although they may be. Different sections may have different cell densities (number of cells per unit cross-sectional area) or may have the same cell densities.

Similarly, the cross-sectional shape of the various pass-through, inlet and outlet cells is not generally considered to be critical to the invention, and also may vary widely. Thus, the cells may be circular, elliptical, regular or irregular polygons (such as square, rectangular, hexagonal, octagonal or triangular and the like) in cross-section, or may have more complex shapes, such as “dumbbell” shapes. Cells of different types may have the same or different shapes as each other. Cells in different sections may have the same or different shapes as each other.

The lengths (axial extensions) of the various sections may be equal to each other, or may vary. Pass-through sections may be longer than, shorter than, or the same length as the downstream sections or other pass-through sections.

The walls of the ceramic honeycomb sections are porous. The porosity of the walls may be as low as 5 volume-% or as high as about 90 volume-%. A preferred porosity is at least 25 volume-%. A more preferred porosity is at least 40 volume-% and a still more preferred porosity is at least 50 volume-%. Porosity can be measured by various immersion or mercury porosimetry methods. The volume average pore diameter of the wall pores preferably is at least 2 microns and especially at least 5 microns, up to 50 microns, up to 35 microns or up to 25 microns. “Pore diameter” is expressed for purposes of this invention as an apparent volume average pore diameter as measured by mercury porosimetry (which assumes cylindrical pores).

Wall thicknesses can vary considerably depending on the application and mechanical requirements such as the needed physical strength. For many filtering applications, typical wall thicknesses are 0.05 to 10 mm, preferably 0.2 to 1 mm.

The gaps between successive axial honeycomb sections can be any convenient length (“length” referring to the axial direction). The length of each gap should be large compared to the pore size of the porous walls of the honeycomb sections, and should be large enough to avoid a large pressure drop between successive segments. The gap preferably is at least 0.1 mm in length, and more preferably at least 1 mm in length and still more preferably at least 4 mm in length. Any longer length is useful, although concerns such as overall part size and cost lead to a preferred gap length of no greater than 150 mm, more preferably no greater than 50 mm, still more preferably no greater than 25 mm and even more no greater than 15 mm.

The honeycomb sections are ceramic materials such as, for example, alumina, zirconia, silicon carbide, silicon nitride, aluminum nitride, silicon oxynitride, silicon carbon nitride, mullite, cordierite, beta spodumene, aluminum titanate, a strontium aluminum silicate or a lithium aluminum silicate, or combinations of any two or more of these ceramic materials. In preferred embodiments, at least a portion of the ceramic honeycomb is an acicular mullite. Different sections may be made of different ceramic materials. If any section is segmented as described below, the various segments in any section may all be made of the same ceramic material, or different segments can be made of different ceramic materials.

Any of the honeycomb segments can contain a catalytic or other functional material coated onto and/or impregnated within the porous walls. Among the useful catalyst types include those which are useful for treatment of engine exhaust fluids (such as diesel engine emissions), such as, for example, direct oxidation catalysts (DOC), three-way catalysts (TWC), soot oxidation catalysts, fuel borne catalysts (FBC), selective catalytic reduction (SCR), lean NOx trap (LNT), and ammonia slip catalysts. Such catalysts are well known and described in “Diesel Emissions and Their Control”, Majewski, W. A., Khair, M. D. SAE International, Warrendale, Pa., 2006 and in “Catalytic Air Pollution Control: Commercial Technology”, Heck, R. M., Farrauto, R. J., Van Nostrand Reinhold, New York, 1995. These catalytic materials include various metals, metal oxides, metal silicates, and metal zeolites. Among the useful metals are barium, platinum, palladium, silver, gold, vanadium, cesium, iron, copper and the like. An advantage of this invention is that such catalytic or functional materials can be applied separately to different sections. When the sections are assembled, a honeycomb assembly can be produced that has the catalytic or functional material restricted to predetermined sections, and/or different catalytic or functional materials located in different sections of the assembly. The assembly may include one or more sections that include no such catalytic or functional material, and one or more sections that contain a catalytic material. In addition to the catalytic materials described above, various organic or inorganic functional materials may be used. Suitable methods for depositing various inorganic materials onto a honeycomb structure are described, for example, in US 205/0113249 and WO2001045828.

Various types of structural means for holding said honeycomb segments in fixed spatial relation to each other are useful. A preferred type of structural means is a peripheral wall (such as walls 19 in the various Figures) as described already. Such a peripheral wall may be an integral skin, an applied skin and/or wrapping, compressible or expandable mat or foam, or an external container that fits tightly around the honeycomb assembly at least in the region of the gap or gaps. Such a peripheral wall may be applied only around the periphery of the gap or gaps, or may, as shown in FIGS. 1-3, extend the entire length of the honeycomb assembly. In addition to such peripheral walls various types of mechanical devices that affix the honeycombs to each other or to an external support in a fixed spatial relationship can serve as the structural. These mechanical devices include, for example, clamping devices and various other types of connectors. The honeycomb sections may be cemented to each other about their periphery, or otherwise cemented or affixed to a support to hold them in a fixed spatial relationship. In some embodiments, in particular when some or all of the honeycomb sections are radially segmented as described below, the structural means may be or include one or more cement layers between the various segments.

The enclosure means encloses the periphery of the gap or gaps between each sequential pair of honeycomb sections and substantially prevents a fluid passing through the honeycomb structure from escaping from the assembly through the periphery of the gap(s). In some embodiments, the same structure functions as both the enclosure means and the structural means. For example, a preferred enclosure means is a peripheral wall (such as walls 19 in the various Figures), which can also function as the structural means which holds the honeycomb sections in a fixed spatial relationship. Cement layers applied to the periphery of a gap are useful as the enclosure means and can also form all or part of the structural means. When the honeycomb sections are radially segmented, cement layers between the various segments can form part of the enclosure means as well as all or part of the structural means. In addition, the enclosure means can include various types of gasketing materials, the gasketing materials being selected to withstand the conditions of use.

A honeycomb assembly of the invention, or any axial section thereof, may be radially segmented for all or a portion of its axial length. By “radially” segmented, it is meant that the honeycomb assembly or axial section is divided along one or more planes that run parallel to the axial extension of the assembly or section (i.e., in the direction of the axial cells), for at least a portion of its length.

At least one of the radial segments includes one or more pass-through honeycomb sections as described herein and at least one downstream ceramic honeycomb section as described herein. The downstream section in any segment is positioned downstream of at least one pass-through ceramic honeycomb section in such segment, with gaps as described herein between each sequential pair of honeycomb sections within a particular section.

Radial segments suitably are bonded together by a cement layer interposed between adjacent segments. The cement layer serves to bond the segments together and, because the cement layer is generally more elastic than the ceramic honeycomb, also helps to reduce peripheral cracking during temperature cycling.

FIG. 4 illustrates an embodiment of such a radially segmented honeycomb assembly. In FIG. 4, honeycomb assembly 41 includes a pass-through honeycomb section 42 and a downstream honeycomb section 44, each of which is radially segmented. Pass-through section 42 is radially segmented into segments 42A and segment 42B, and downstream honeycomb section 44 is segmented into segments 44A and segment 44B. Cement layers 43A bond segments 42A and 42B to adjacent honeycomb segments. Cement layers 43B bond segments 44A and 44B to adjacent honeycomb segments. As before, pass-through honeycomb section 42 contains pass-through cells 4, and inlet cells 6 which are closed at outlet end 8 of pass-through section 42. Also, as before, downstream honeycomb section 44 includes inlet cells 6, which are closed at outlet end 10, and outlet cells 13, which are closed at inlet end 9 of downstream honeycomb section 44. Porous walls 16 separate adjacent cells. As before, gap 18 separates pass-through section 42 from downstream section 44. Peripheral wall 19 surrounds the periphery of honeycomb assembly 41. In this embodiment, peripheral wall 19 holds pass-through honeycomb section 42 and downstream honeycomb section 44 in a fixed spatial relationship, and prevents fluid from escaping from the periphery of gap 18.

In FIG. 4 pass-through section 42 is shorter in length than downstream section 44, but this is not critical. As before, the lengths of the various sections can be the same or different, and the downstream sections can be longer than, shorter than, or the same length as any pass-through section.

FIG. 5 illustrates another embodiment (41A) of the invention, in which the honeycomb sections are radially segmented. The various features of FIG. 5 are the same as those in FIG. 4 that bear the same reference numeral. In FIG. 5, pass-through honeycomb segment 42B is shorter than pass-through honeycomb segments 42A. Additionally, downstream honeycomb segment 44B is longer than downstream honeycomb segments 44A. As a result of this, gap 18B between pass-through honeycomb segment 42B and downstream honeycomb segment 44B is off-set in relation to gaps 18A. An advantage of this design is that a single-piece assembly is formed, with cement layers 43 serving as means for maintaining the honeycomb sections and segments in a fixed spatial relationship. With this design, it is not necessary to provide an external means for holding the honeycomb sections and segments into a fixed spatial relationship, although such an external means may be present.

Yet another variation is illustrated in FIG. 6. The various features of FIG. 6 are the same as those in FIGS. 4 and 5 that bear the same reference numeral. In FIG. 6, central honeycomb 45 is not axially divided, and extends for the entire length of honeycomb assembly 60. As with the FIG. 5 embodiment, an advantage of this design is that a single-piece assembly is formed, with cement layers 43 serving as means for maintaining the various honeycombs in a fixed spatial relationship. With this design, it is not necessary to provide an external means for holding the honeycomb sections and segments into a fixed spatial relationship, although such an external means also may be present.

Honeycomb assemblies of the invention can be prepared by (1) forming the individual honeycomb sections, (2) blocking cells of the honeycomb sections to form pass-through, inlet and outlet cells as described before, and (3) assembling the individual honeycomb sections into fixed spatial relationship with gaps between each pair of successive honeycomb sections and enclosing the gaps. Among the ways of performing step (3) are, for example, (a) applying a skin or wrap to the honeycomb sections, which skin or wrap at least encloses the gaps between each successive pair of honeycomb sections, (b) placing the honeycomb sections into a container that holds the sections in the needed spatial relationship and encloses the gaps and/or, in some cases, (c) adhering the honeycomb sections together. Other methods of performing step (3) also can be used. If some or all of the honeycomb sections are radially segmented, then a step of assembling the radial segments may be performed before or as part of step (3).

A skin or wrap that is applied during step (3) preferably includes a cement material that requires firing. In such a case, step (3) includes such a firing step.

In step (3), gaps can be established by inserting a fugitive spacer between each successive pair of honeycomb sections and removing the spacer once the honeycombs are fixed into the necessary spatial relationship. The spacer is preferably a material that decomposes, reacts or volatilizes to form one or more gasses at moderately elevated temperatures, such as 100 to 1200° C., especially 200 to 500° C. Examples of such a material include various organic materials such as lignocelluosics (including, for example, paper and plant matter), and a wide range of organic polymers. In such a case, the assembly is heated to the requisite temperature to convert the fugitive spacer into a gas. When the peripheral skin is a cement material that needs firing, the fugitive spacer can be removed at the same time the firing step is performed.

Honeycomb assemblies of the invention are useful in a wide range of filtering applications, particularly those involving high temperature operation and/or operation in highly corrosive and/or reactive environments in which organic filters may not be suitable. One use for the filters is in combustion exhaust gas filtration applications, especially for mobile power plants such as vehicle engines. Thus, the filters are useful as diesel exhaust filters and as other vehicular exhaust filters. In general, the honeycomb assemblies of the invention can be used in the same manner as conventional ceramic honeycomb filters; no special conditions are needed with respect to the use of the honeycomb assemblies of the invention.

The following examples are provided to illustrate the invention, but are not intended to limit the scope thereof. All parts and percentages are by weight unless otherwise indicated.

### EXAMPLE 1 AND COMPARATIVE SAMPLE A

Nine identical honeycombs with a square cross-section are prepared. Each is approximately 20.3 cm in length and 8.0 cm×8.0 cm in cross-section. Each contains about 31 cells per square centimeter (about 200 cells/in²) of cross-sectional area. Wall thickness is 265 μm; wall porosity is 68.6% and the pore size is 10.7 m. These honeycombs are arranged in a 3×3 pattern and cemented together. The resulting assembly is then cut into a cylinder having a diameter of about 22.9 cm and a length of 20.3 cm. The resulting cylinder is then cut to produce two segmented honeycomb sections, one 3.8 cm in length and the other 16.5 cm in length.

The 3.8 cm section is formed into a pass-through section by plugging alternating cells at the outlet end in a checkerboard pattern, to form equal numbers of pass-through cells and inlet cells (and no outlet cells). The 16.5 cm section is formed into a downstream section by plugging alternating cells at each end in a checkerboard pattern, to form equal numbers of inlet cells and outlet cells (and no pass-through cells). A 3-5 mm-thick paper spacer is then placed between the outlet end of the pass-through section and one end of the downstream section. A cement skin is then applied to the periphery and the resulting assembly fired to dry the cement, produce a peripheral cement wall and remove the paper spacer, leaving a 3-5 mm gap between the honeycomb sections. The resulting axially divided honeycomb is designated as Example 1.

For comparison, an otherwise identical honeycomb filter is made in the same manner, except the filter is not axially divided. The cells are plugged at each end in a checkerboard pattern to form equal numbers of inlet and outlet cells (and no pass-through cells). This filter is designated as Comparative Sample A.

Pressure drop through each of Example 1 and Comparative Sample A is measured by flowing room temperature air through each of them at a flow rate of 130 cubic meters/hour. The pressure drop through Example 1 is 0.177 kPa, which is slightly higher than the 0.144 kPa pressure drop through Comparative Sample A. Some higher pressure drop is expected in Example 1, as some of the gas flowing through Example 1 must pass through two cell walls as it flows through the filter.

Thermal shock resistance of each of Example 1 and Comparative Sample A is evaluated using a cyclic burner test. The filter is placed into a can and connected to inlet and outlet pipes through two cones. Fuel is injected into a burner to generate hot air, which is introduced to the can through the inlet cone and removed from the outlet cone. Thermal shock conditions are established through control of the rate of temperature increase and the flow rate. The test regime consists of seven increasingly severe sets of conditions. The part is cycled through each of these sets of conditions 10 times before being passed to the next, more severe set of conditions. After the part is cycled 10 times though a set of conditions, it is inspected for cracking before being subject to the next set of conditions. The test conditions are:

| | Rate of Temperature Increase, | Flow rate, cubic |
|---|---|---|
| Level | ° C./min | feet/minute |
| 1 | 200 | 100 |
| 2 | 200 | 53 |
| 3 | 250 | 100 |
| 4 | 250 | 53 |
| 5 | 300 | 100 |
| 6 | 300 | 53 |
| 7 | 350 | 53 |
| 8 | 400 | 53 |

Comparative Sample A fails level 2 of this test, but Example 1 passes level 2.

### EXAMPLE 2 AND COMPARATIVE SAMPLE B

Example 2 is prepared in the same manner as Example 1, except the segmented honeycomb cylinder is cut into two sections of equal length, which are then plugged and skinned to form the axially divided honeycomb assembly. Comparative Sample B is made in the same manner as Comparative Sample A.

The pressure drop through Example 2 is 0.184 kPa and that through Comparative Sample B is 0.138 kPa. Again, a small increase in pressure drop is seen in the example of the invention, because some of the gas flowing through that filter must pass through two cell walls.

### EXAMPLE 3

Honeycomb assembly Example 3 is prepared in the same general manner as Example 1, except the individual honeycombs each are cut into one 8.9 cm piece and one 11.4 cm pieces. One of the 8.9 cm pieces and eight of the 11.4 cm pieces are formed into pass-through sections by plugging alternating cells at the outlet end in a checkerboard pattern, to form equal numbers of pass-through cells and inlet cells (and no outlet cells). The remaining eight 8.9 cm pieces and the one remaining 11.4 cm piece are formed into downstream sections by plugging alternating cells at each end in a checkerboard pattern to form equal numbers of inlet cells and outlet cells (and no pass-through cells). The plugged sections are then cemented into a 3×3 honeycomb assembly as shown in FIG. 5, with the 8.9 cm pass-through section, the 11.4 cm pass-through sections, the 11.4 cm downstream section and the 8.9 cm downstream sections corresponding to sections 42B, 42A, 44B and 44A, respectively, in FIG. 5. A 3-5 mm-thick paper spacer is then placed between the outlet end of each pass-through section and the inlet end of the following downstream section. A cement skin is then applied to the periphery and the resulting assembly fired to dry the cement, produce a peripheral cement wall and remove the paper spacer, leaving a 3-5 mm gap between the honeycomb sections.

The fracture strength and Young's modulus of Example 3 and Comparative Sample B are measured according to ASTM C1161-94, ASTM 1259-98. Material thermal shock factor (MTSF) is calculated from the measured values and the coefficient of thermal expansion, as follows:

MTSF=fracture strength/(CTE×Young's modulus)

The units of MTSF are ° C., with higher values indicating better thermal shock resistance. Example 3 has a fracture strength of 24.0 mPa, a Young's modulus of 21.5 GPa, and a MTSF of 214° C. Comparative Sample B has a fracture strength of 24.8 mPa, a Young's modulus of 21.9 GPa and a MTSF of 214° C. These values indicate very little difference in mechanical properties and thermal shock resistance.

Pressure drop through Example 3 and Comparative Sample B are 0.169 kPa, and 0.138 kPa, respectively.

Thermal shock resistance of each of Example 3 and Comparative Sample B is evaluated using the cyclic burner test described in Example 1.

Comparative Sample B fails level 2. Example 3, however, passes the first seven levels, failing only under the most stringent conditions of level 8 of this test.

### EXAMPLE 4

Honeycomb assembly Example 4 is prepared in the same general manner as Example 1, except that eight of the individual honeycombs are each cut into one 3.8 cm piece and one 16.5 cm piece. The ninth honeycomb is uncut. The uncut honeycomb is plugged in a checkerboard pattern at each end to form equal numbers of inlet and outlet cells (and no pass-through cells). The 3.8 cm honeycombs are formed into pass-through sections by plugging alternating cells at the outlet end in a checkerboard pattern, to form equal numbers of pass-through cells and inlet cells (and no outlet cells). The 16.5 cm honeycombs are formed into downstream sections by plugging alternating cells at each end in a checkerboard pattern, to form equal numbers of inlet cells and outlet cells (and no pass-through cells). The plugged honeycombs are then cemented into a 3×3 honeycomb assembly as shown in FIG. 6, with the uncut honeycomb, the 3.8 cm pass-through honeycombs, and the 16.5 cm downstream honeycombs corresponding to sections 45, 42A and 44A, respectively, in FIG. 6. A 3-5 mm-thick paper spacer is then placed between the outlet end of each pass-through section and the inlet end of the adjacent downstream section. A cement skin is then applied to the periphery and the resulting assembly fired to dry the cement, produce a peripheral cement wall and remove the paper spacer, leaving a 3-5 mm gap between the honeycomb sections.

Pressure drop through Example 4 is 0.163 kPa, which is only slightly higher than that of Comparative Sample A (0.144 kPa).

1. A ceramic honeycomb assembly comprising one or more pass-through ceramic honeycomb sections and one or more downstream ceramic honeycomb sections, the ceramic honeycomb sections being arranged sequentially in an axial direction with a gap between each sequential pair of honeycomb sections, structural means for holding said honeycomb segments in fixed spatial relation to each other and enclosure means for enclosing the periphery of the gap or gaps between each sequential pair of honeycomb sections, wherein:
(a) at least one downstream ceramic honeycomb section is positioned downstream of at least one pass-through ceramic honeycomb section;
(b) the pass-through and downstream ceramic honeycomb sections each have multiple axially-extending cells that are defined by intersecting porous walls;
(c) the axially-extending cells of the pass-through ceramic honeycomb section or sections and the axially-extending cells of the downstream honeycomb section or sections together define multiple fluid flow paths through the ceramic honeycomb assembly from an upstream end to a downstream end;
(d) each pass-through ceramic honeycomb section includes (i) at least 15% by number of pass-through cells that are open at each end to form pathways for a fluid to flow through the pass-through ceramic honeycomb without passing through a cell wall and (ii) inlet cells that are closed at an outlet end of said pass-through ceramic honeycomb section but not an inlet end thereof, such that a fluid entering such inlet cells must pass through at least one cell wall is it passes through said pass-through ceramic honeycomb; and
(e) each downstream ceramic honeycomb section includes (i) outlet cells that are closed at an inlet end but not at an outlet end of said downstream ceramic honeycomb section, (ii) inlet cells that are closed at an outlet end but not an inlet end of said downstream ceramic honeycomb section, such that a fluid entering an inlet end of said inlet cells must pass through a cell wall to be removed from the outlet end of said downstream ceramic honeycomb, and (iii) 0 to 10% by number of pass-through cells that are open at each end to form pathways for a fluid to flow through the downstream ceramic honeycomb without passing through a cell wall.

2. The ceramic honeycomb assembly of claim 1, wherein a downstream section is the last section in the assembly.

3. The ceramic honeycomb assembly of claim 1, which contains only one downstream section.

4. The ceramic honeycomb assembly of claim 1, wherein the downstream section contains no pass-through cells.

5. The ceramic honeycomb assembly of claim 1, which contains at least two pass through sections followed by a downstream section.

6. The ceramic honeycomb assembly of claim 1, wherein a peripheral wall forms the structural means and the enclosure means.

7. The ceramic honeycomb assembly of claim 1, wherein a can forms the structural means and the enclosure means.

8. The ceramic honeycomb assembly of claim 1, wherein each gap is 1 to 25 mm in length.

9. The ceramic honeycomb assembly of claim 1, which is radially segmented for at least a portion of its length.

10. The ceramic honeycomb assembly of claim 9 wherein each radial segment includes at least one downstream honeycomb section positioned downstream of at least one pass-through honeycomb section with a gap between each sequential pair of honeycomb sections.

11. The ceramic honeycomb assembly of claim 9, wherein at least one gap of at least one radial segment is offset from the gaps of adjacent radial segments.

12. The ceramic honeycomb assembly of claim 9, wherein at least one of the radial segments extends the entire length of the honeycomb assembly, and at least one of the radial segments includes at least one downstream honeycomb section positioned downstream of at least one pass-through honeycomb section with a gap between each sequential pair of honeycomb sections.

13-14. (canceled)

15. A method of forming a ceramic honeycomb assembly of claim 1, comprising (1) forming ceramic honeycombs, (2) blocking cells of at least one of the honeycomb to form a pass-through honeycomb section having inlet and outlet cells and blocking cells of at least one other honeycomb to form a downstream honeycomb section having inlet and outlet cells and 0 to 10% by number of pass-through cells, and (3) assembling the pass-through honeycomb section(s) and downstream honeycomb section(s) into a fixed spatial relationship with at least one downstream honeycomb section positioned after at least one pass-through section with gaps between each pair of successive honeycomb sections and enclosing the gaps.

16. The method of claim 15 wherein the gaps are formed by inserting a fugitive spacer between each successive pair of honeycomb sections and firing the assembly to remove the fugitive spacer and form the gaps.

17. A method for removing particulate matter from a combustion exhaust stream, comprising passing the combustion exhaust stream through a ceramic honeycomb assembly of claim 16.
